(19) United States
(12) Patent Application Publication
(10) Pub. No.: US 2025/0217121 A1
(43) Pub. Date: Jul. 3, 2025

(54) CODE PROPERTY MANAGEMENT SYSTEM BASED ON COMPILATION OF CLOUD INTELLIGENT CONTRACT

(71) Applicant: JIANGNAN UNIVERSITY, Wuxi (CN)

(72) Inventors: Zhenping XIE, Wuxi (CN); Wei WANG, Wuxi (CN); Hangyu ZHU, Wuxi (CN); Yuxiang FAN, Wuxi (CN); Yuan LIU, Wuxi (CN); Qianyi ZHAN, Wuxi (CN)

(21) Appl. No.: 18/946,870

(22) Filed: Nov. 13, 2024

Related U.S. Application Data
(63) Continuation of application No. PCT/CN2024/075146, filed on Feb. 1, 2024.

(30) Foreign Application Priority Data
Dec. 27, 2023 (CN) 202311837781.5

(51) Int. Cl. G06F 8/41; G06F 8/60; G06F 9/455; G06F 21/12

(52) U.S. Cl. CPC G06F 8/41; G06F 8/60; G06F 9/455; G06F 21/125; G06F 2221/2107

(57) ABSTRACT

A code property management system based on compilation of a cloud intelligent contract is disclosed. The system obtains, through a cloud intelligent contract deployed in a cloud environment, code property data stored in an authorization storage subsystem, and performs compilation through a Docker mirror to generate a Docker software product. A Docker technology provides operating system-level isolation for controllable construction of a software product, and then uses a feature that execution is triggered when the intelligent contract meets a preset rule, to implement efficient and automated construction of the software product. A management public key of a code project is used for encrypting and storing corresponding code property data in a repository. A management private key in the same key pair is used for decrypting the corresponding code property data when compilation is required, thereby effectively improving security and integrity of the code property data.

### TECHNICAL FIELD

This application relates to the field of distributed technologies, and in particular, to a code property management system based on compilation of a cloud intelligent contract.

### BACKGROUND

With the development of Internet technologies, innovation and transaction of software products are increasingly frequent. Software code is the core asset of software products, and protection and management of property of the software code become an important issue. For a conventional code property, during circulation and use of the software product, due to duplicability of the software code, the software code is easily leaked. Consequently, it is difficult to effectively protect the code property. Therefore, how to effectively protect code property of a software product during use of the software product is a challenge that urgently needs to be resolved.

### SUMMARY

### Technical Problem

In the related art, it is difficult to protect code property during circulation and use of a software product.

### Technical Solution

In view of the foregoing proposed technical problem and technical requirement in which it is difficult to protect code property during circulation and use of a software product, the applicant proposes a code property management system based on compilation of a cloud intelligent contract. The technical solution of this application are as follows:

A code property management system based on compilation of a cloud intelligent contract is provided, including an authorization storage subsystem, a software compilation subsystem, and a software use platform. The authorization storage subsystem and the software compilation subsystem are both deployed in a cloud environment. The authorization storage subsystem includes a repository and is deployed with a cloud intelligent contract, the repository correspondingly stores a property identifier and encrypted code property data of at least one code project, and code property data of each code project is encrypted by using a management public key of the code project.

The software use platform is configured to receive a construction request sent by a consumer user node, and the construction request carries a target property identifier and a target compiling environment corresponding to a target code project. The software use platform is further configured to send, based on the target property identifier, the construction request to a creator user node corresponding to the target code project, and send the construction request to the software compilation subsystem after receiving an authorization response from the creator user node corresponding to the target code project for the construction request.

The software compilation subsystem is configured to parse the received construction request and send the target property identifier to the authorization storage subsystem.

The authorization storage subsystem is configured to invoke the cloud intelligent contract to obtain encrypted target code property data corresponding to the target property identifier from the repository, and return the encrypted target code property data to the software compilation subsystem.

The software compilation subsystem is configured to push the encrypted target code property data to a virtual machine configured based on the target compiling environment, and compile the target code property data after decryption by using a management private key of the target code project in an isolated environment provided by the virtual machine, to generate a target Docker software product, where the target Docker software product is a Docker mirror of a software service for the construction request. The management public key and the management private key of each code project are a key pair.

The software use platform is configured to deliver the target Docker software product to the consumer user node that sends the construction request.

In a further technical solution, the code property management system further includes a creating platform, and the repository includes an interplanetary file system and a blockchain.

The creating platform is configured to obtain code property data of a code project uploaded by the creator user node and a user identifier of a corresponding management node and upload the code property data and the user identifier to the authorization storage subsystem, and a management node of each code project is a creator user node of the code project.

After receiving the code property data of the code project and the user identifier of the corresponding management node, the authorization storage subsystem reads a public key corresponding to the user identifier of the management node from the blockchain as the management public key of the code project, and triggers the cloud intelligent contract to generate the property identifier of the code project. The authorization storage subsystem is further configured to encrypt unstructured data in the code property data by using the management public key of the code project and then store the unstructured data in the interplanetary file system and obtain a storage address, and encrypt structured data in the code property data by using the management public key of the code project and then store the structured data in the blockchain corresponding to the property identifier of the code project and the storage address.

That the encrypted target code property data corresponding to the target property identifier is obtained from the repository includes: obtaining a storage address and encrypted structured data corresponding to the target property identifier from the blockchain, and obtaining encrypted unstructured data corresponding to the storage address from the interplanetary file system, where the obtained encrypted target code property data includes the encrypted structured data and the encrypted unstructured data.

In a further technical solution, that the creating platform obtains the code property data of the code project uploaded by the creator user node includes:

obtaining local data uploaded by a plurality of creator user nodes with collaborative permission, and correspondingly storing user identifiers of all the creator user nodes with the collaborative permission and the local data uploaded by the creator user nodes, to obtain the code property data of the code project.

Each creator user node has consult permission for the local data uploaded by all the creator user nodes of the code project with the collaborative permission.

In a further technical solution, each software product has a corresponding total lifetime.

The software use platform is further configured to stop delivering the target Docker software product to the consumer user node and send a destruction request for the target Docker software product to the software compilation subsystem when detecting that accumulative use duration of the target Docker software product delivered to the consumer user node reaches a total lifetime of the target Docker software product.

The software compilation subsystem destructs the target Docker software product based on the received destruction request and recycles a port number of the target Docker software product, where different target Docker software products are respectively assigned different port numbers.

In a further technical solution, the software use platform is further configured to push a payment bill to the consumer user node of the target Docker software product when detecting that the accumulative use duration of the target Docker software product delivered to the consumer user node reaches the total lifetime of the target Docker software product, and after detecting a payment completion operation in response to the payment bill, perform the step of stopping delivering the target Docker software product to the consumer user node and sending the destruction request for the target Docker software product to the software compilation subsystem.

In a further technical solution, the code property management system further includes a service supervision subsystem.

The software use platform is further configured to, after detecting the payment completion operation in response to the payment bill, send a transaction record registration request to a blockchain in the repository through the service supervision subsystem, where transaction information carried in the transaction record registration request at least includes a product identifier of the target Docker software product, a user identifier of the consumer user node, and transaction process data. The blockchain generates an order contract based on the transaction record registration request and completes storage through a multi-node consensus mechanism.

The software use platform is further configured to, when receiving a query request sent by the consumer user node, send the query request to the blockchain, and deliver a received order contract returned by the blockchain to the consumer user node. The query request carries the user identifier of the consumer user node and/or the product identifier of the target Docker software product.

In a further technical solution, the construction request received by the software use platform includes a basic lifetime.

When the software use platform does not receive a delay request before the accumulative use duration of the target Docker software product delivered to the consumer user node reaches the basic lifetime, the total lifetime of the target Docker software product is determined as the basic lifetime.

When the software use platform receives a delay request carrying delay duration before the accumulative use duration of the target Docker software product delivered to the consumer user node reaches the basic lifetime, the software use platform sends the delay request to a creator user node corresponding to a target code project encapsulated in the target Docker software product, and after receiving agreement feedback from the creator user node corresponding to the target code project for the delay request, determines the total lifetime of the target Docker software product as a sum of the basic lifetime and the delay duration.

In a further technical solution, the software use platform is further configured to perform the following operations:

when a suspension request carrying suspension duration sent by the consumer user node is received in a process of delivering the target Docker software product to the corresponding consumer user node, sending the suspension request to a creator user node corresponding to a target code project encapsulated in the target Docker software product.

After receiving agreement feedback from the creator user node corresponding to the target code project for the suspension request, delivery of the target Docker software product to the corresponding consumer user node is suspended until the suspension duration is reached, and the target Docker software product is continued to be delivered to the corresponding consumer user node, where the accumulative use duration of the target Docker software product does not increase in a process of suspending the delivery.

In a further technical solution, the code property management system further includes a service supervision subsystem, and the service supervision subsystem is further configured to upload and store transactional data corresponding to the construction request to a blockchain of the repository through a multi-node consensus mechanism, the transactional data corresponding to each construction request includes a user identifier of the consumer user node sending the construction request, process data for compiling and generating the target Docker software product by the software compilation subsystem, and usage data for delivering the target Docker software product by the software use platform to the corresponding consumer user node.

In a further technical solution, the creating platform generates a corresponding key pair for each creator user node that completes registration, correspondingly stores a user identifier of the creator user node and a public key in the generated key pair in the blockchain, and returns a private key in the generated key pair to the creator user node.

### Beneficial Effects

This application discloses a code property management system based on compilation of a cloud intelligent contract. The system obtains, through a cloud intelligent contract deployed in a cloud environment, code property data stored in an authorization storage subsystem, and performs compilation through a Docker mirror to generate a Docker software product. A Docker technology provides operating system-level isolation for controllable construction of a software product, and then uses a feature that execution is triggered when the intelligent contract meets a preset rule, to implement efficient and automated construction of the software product. A management public key of a code project is used for encrypting and storing corresponding code property data in a repository. A management private key in the same key pair is used for decrypting the corresponding code property data when compilation is required, thereby effectively improving security and integrity of the code property data during circulation and use of software, and avoiding a risk of code leakage and abuse.

In this application, an interplanetary file system and a blockchain are used as a repository, to implement data access based on a cloud intelligent contract. The interplanetary file system implements distributed and decentralized storage of unstructured data, and improves addressable and reliability of data. The blockchain implements addition and backup of structured data, thereby improving non-tamperability of the data and resolving a problem of a single point of failure.

In this application, a pooling technology and mutual exclusion are used, to implement effective assignment and management of port numbers, and avoid a problem of port number conflict.

In this application, the service supervision subsystem monitors service usage data in a software use process, and uploads transactional data consensus in the service supervision subsystem to the blockchain for evidencing, thereby improving transparency and traceability of software service transactions.

In this application, issuance and maintenance of a user identifier are implemented through a digital certificate authority, thereby improving creditability and security of a code property management system.

### BRIEF DESCRIPTION OF THE DRAWINGS

FIG. 1 is a schematic structural diagram of a code property management system according to an embodiment of this application.

FIG. 2 is a schematic diagram of a process of generating software through compilation of a cloud intelligent contract according to an embodiment of this application.

FIG. 3 is a schematic diagram of service supervision of a software product according to an embodiment of this application.

### DETAILED DESCRIPTION

Specific implementations of this application are further described in the following with reference to the accompanying drawings.

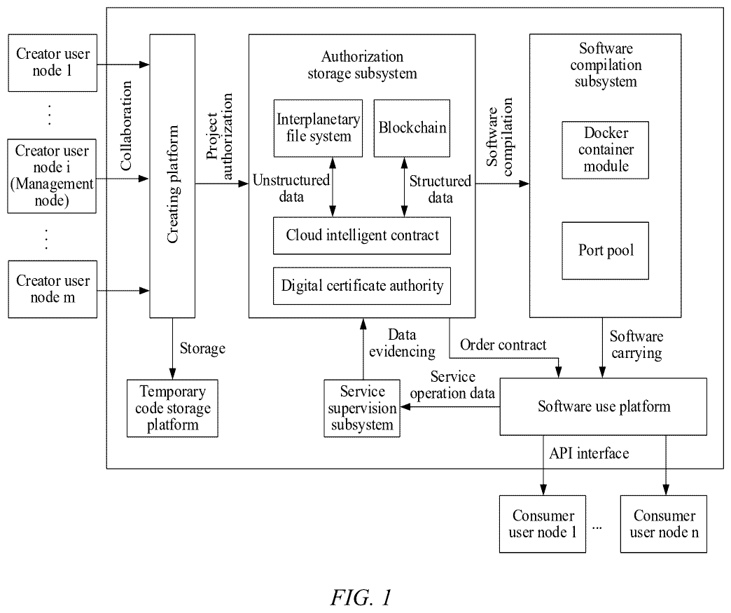

As shown in FIG. 1, a code property management system based on compilation of a cloud intelligent contract is provided, including an authorization storage subsystem, a software compilation subsystem, and a software use platform. The authorization storage subsystem and the software compilation subsystem are both deployed in a cloud environment. The authorization storage subsystem includes a repository and is deployed with a cloud intelligent contract, the repository correspondingly stores a property identifier and encrypted code property data of at least one code project, and code property data of each code project is encrypted by using a management public key of the code project.

In an embodiment, each code project matches a pair of management keys. Each pair of management keys includes a management public key and a management private key. The management key is generated in advance and stored in a repository. The management public key is configured for encrypting code property data of the corresponding code project. The management private key is configured for decrypting the code property data of the corresponding code project.

To implement interaction between a plurality of users during circulation and use of code property, the code property management system in this application is further connected to several user nodes. The user nodes include a consumer user node and a creator user node. The consumer user node corresponds to a consumer of the code property, and the creator user node corresponds to a creator of the code property. A relationship between each code project and the creator user node is correspondingly stored in the repository.

The software use platform is configured to receive a construction request sent by a consumer user node, and the construction request carries a target property identifier and a target compiling environment corresponding to a target code project. The software use platform is further configured to send, based on the target property identifier, the construction request to a creator user node corresponding to the target code project, and send the construction request to the software compilation subsystem after receiving an authorization response from the creator user node corresponding to the target code project for the construction request.

Optionally, the target compiling environment represents an environment on which the target code project depends during compilation and running.

In an embodiment, the authorization response of the creator user node for the construction request represents that the creator user node agrees to the construction request and authorizes the consumer user node.

Optionally, when the software use platform receives a rejection response from the creator user node corresponding to the target code project for the construction request, or does not receive a response from the creator user node corresponding to the target code project for the construction request within set time, the software use platform sends rejection feedback to the consumer user node.

The software compilation subsystem is configured to parse the received construction request and send the target property identifier to the authorization storage subsystem.

The authorization storage subsystem is configured to invoke the cloud intelligent contract to obtain encrypted target code property data corresponding to the target property identifier from the repository, and return the encrypted target code property data to the software compilation subsystem.

The software compilation subsystem is configured to push the encrypted target code property data to a virtual machine configured based on the target compiling environment, and compile the target code property data after decryption by using a management private key of the target code project in an isolated environment provided by the virtual machine, to generate a target Docker software product, where the target Docker software product is a Docker mirror of a software service for the construction request. The management public key and the management private key of each code project are a key pair.

In another embodiment, each creator user node matches a pair of keys, and a relationship between the creator user node, and the keys and the code project is correspondingly stored in the repository.

Optionally, when the code project has a plurality of creator user nodes, at least one creator user node is used as a management node, a public key of the management node is a management public key, and a private key of the management node is a management private key.

Optionally, a Rivest-Shamir-Adleman (RSA) algorithm is used for generating a pair of RSA keys for each creator user node. Each pair of RSA keys includes a public key and a private key, public keys of pairs of RSA keys are different from each other, and private keys of the pairs of RSA keys are different from each other.

In an embodiment, to ensure efficient collaboration, the public key is stored in a database. To improve privacy and security, the private key is stored locally by the creator user node.

Optionally, the software compilation subsystem includes a Docker container module, and compilation of the Docker software product is implemented based on the Docker container module.

Optionally, after decrypting the target code property data, the software compilation subsystem compares a group of hash values when the code property data is stored in the repository with a group of hash values when the code property data is retrieved from the repository. When the two groups of hash values are different, the software compilation subsystem does not respond to the construction request. When the two groups of hash values are the same, the software compilation subsystem performs the step of compiling the target code property data to generate the target Docker software product.

The software use platform of the code property management system in this application is connected to several consumer user nodes, and the consumer user nodes interact with the creator user nodes through the software use platform, thereby implementing use of a software product corresponding to the code property.

The software use platform is configured to deliver the target Docker software product to the consumer user node that sends the construction request.

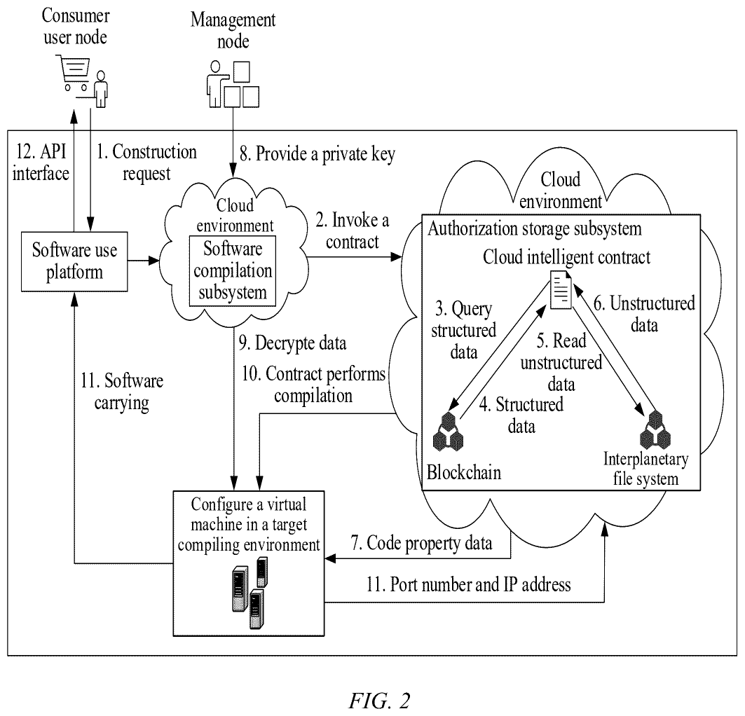

In an embodiment, as shown in FIG. 2, a process of generating software through compilation of a cloud intelligent contract includes: step 1: after receiving the construction request sent by the consumer user node, the software use platform sends the construction request to the software compilation subsystem. step 2: the software compilation subsystem invokes an cloud intelligent contract based on the construction request; the cloud intelligent contract performs steps 3 to 7; step 8: the software compilation subsystem receives the management private key provided by the management node; step 9: the software compilation subsystem decrypts the code property data in the virtual machine based on the management private key; step 10: the cloud intelligent contract performs compilation; step 11: the repository in the authorization management subsystem stores a port number of the Docker software product and an IP address of the virtual machine; step 12: the software use platform carries the Docker software product; and step 13: the software use platform delivers, by exposing an API interface, the Docker software product to the consumer user node that sends the construction request.

In this application, a Docker technology provides operating system-level isolation for controllable construction of a software product, and then uses a feature that execution is triggered when the intelligent contract meets a preset rule, to implement efficient and automated construction of the software product. A management public key of a code project is used for encrypting and storing corresponding code property data in a repository. A management private key in the same key pair is used for decrypting the corresponding code property data when compilation is required, thereby effectively improving security and integrity of the code property data during circulation and use of software, and avoiding a risk of code leakage and abuse.

To describe the code property management system based on compilation of a cloud intelligent contract in this application more clearly, details are provided below through another embodiment.

As shown in FIG. 1, the code property management system in this application further includes a creating platform. The creating platform is connected to several creator user nodes. The repository includes an interplanetary file system and a blockchain.

The creating platform is configured to obtain code property data of a code project uploaded by the creator user node and a user identifier of a corresponding management node and upload the code property data and the user identifier to the authorization storage subsystem, and a management node of each code project is a creator user node of the code project.

Optionally, the creating platform is configured to obtain a code property registration application uploaded by the creator user node and send the code property registration application to the authorization storage subsystem. The code property registration application carries code property data of the code project and a user identifier of a corresponding management node.

Optionally, the code property registration application further carries at least one of a project name, a project version number, a compiling environment, a project introduction, or a request time.

After receiving the code property data of the code project and the user identifier of the corresponding management node, the authorization storage subsystem reads a public key corresponding to the user identifier of the management node from the blockchain as the management public key of the code project, and triggers the cloud intelligent contract to generate the property identifier of the code project. The authorization storage subsystem is further configured to encrypt unstructured data in the code property data by using the management public key of the code project and then store the unstructured data in the interplanetary file system and obtain a storage address, and encrypt structured data in the code property data by using the management public key of the code project and then store the structured data in the blockchain corresponding to the property identifier of the code project and the storage address.

That the encrypted target code property data corresponding to the target property identifier is obtained from the repository includes: obtaining a storage address and encrypted structured data corresponding to the target property identifier from the blockchain, and obtaining encrypted unstructured data corresponding to the storage address from the interplanetary file system, where the obtained encrypted target code property data includes the encrypted structured data and the encrypted unstructured data.

Optionally, the unstructured data in the code property data includes source code of the code project, and the structured data in the code property data includes at least one of a user identifier and a user name of each creator user node of the code project, an authorization time of the code project, a project name, a project version number, or a compiling environment.

Optionally, the cloud intelligent contract operates on the code project by using a Message-Digest Algorithm 5 (MD5) algorithm, to generate the property identifier of the code project.

In this application, an interplanetary file system and a blockchain are used as a repository, to implement data access based on a cloud intelligent contract. The interplanetary file system implements distributed and decentralized storage of unstructured data, and improves addressable and reliability of data. The blockchain implements addition and backup of structured data, thereby improving non-tamperability of the data and resolving a problem of a single point of failure.

In this embodiment, that the creating platform obtains the code property data of the code project uploaded by the creator user node includes:

obtaining local data uploaded by a plurality of creator user nodes with collaborative permission, and correspondingly storing user identifiers of all the creator user nodes with the collaborative permission and the local data uploaded by the creator user nodes, to obtain the code property data of the code project.

In this embodiment, the creator user node of the code project includes a management node and a creator user node with collaborative permission for the code project.

Each creator user node has consult permission for the local data uploaded by all the creator user nodes of the code project with the collaborative permission.

In another embodiment, the local data uploaded by the creator user node is correspondingly stored in a temporary code storage platform. After a creator user node stores the local data, other creator user nodes with the collaborative permission of the same code project may consult and download the local data, add and/or modify the local data based on the local data, and store the local data in the temporary code storage platform, to implement collaborative creation of the code project.

Optionally, the creator user node directly uploads the locally created local data to the creating platform, and/or the creator user node creates the local data online through the creating platform.

Optionally, the local data is temporarily stored by using a MySQL database.

In this embodiment, each software product has a corresponding total lifetime. The software use platform is further configured to stop delivering the target Docker software product to the consumer user node and send a destruction request for the target Docker software product to the software compilation subsystem when detecting that accumulative use duration of the target Docker software product delivered to the consumer user node reaches a total lifetime of the target Docker software product.

The software compilation subsystem destructs the target Docker software product based on the received destruction request and recycles a port number of the target Docker software product, where different target Docker software products are respectively assigned different port numbers.

In an embodiment, a port pool is matched for the software compilation subsystem, several unassigned port numbers are stored in the port pool, and a corresponding port number is recycled to the port pool after the Docker software product is destructed.

Optionally, the port numbers are assigned by using a mutual exclusion pair, and a port number is assigned to at most one Docker software product at the same moment.

Optionally, the API interface of the Docker software product is exposed to the consumer user node through the port number and the IP address of the virtual machine, and the consumer user node accesses the corresponding Docker software product through the API interface.

Optionally, when the Docker software product is destructed, the software compilation subsystem deletes corresponding code property data and a Docker mirror in the virtual machine, releases the port number and a computing resource, and clears a temporary file.

In this embodiment, the software use platform is further configured to push a payment bill to the consumer user node of the target Docker software product when detecting that the accumulative use duration of the target Docker software product delivered to the consumer user node reaches the total lifetime of the target Docker software product, and after detecting a payment completion operation in response to the payment bill, perform the step of stopping delivering the target Docker software product to the consumer user node and sending the destruction request for the target Docker software product to the software compilation subsystem.

Optionally, after receiving the payment bill, the consumer user node cannot send a construction request corresponding to any code project to the software use platform before the payment is completed.

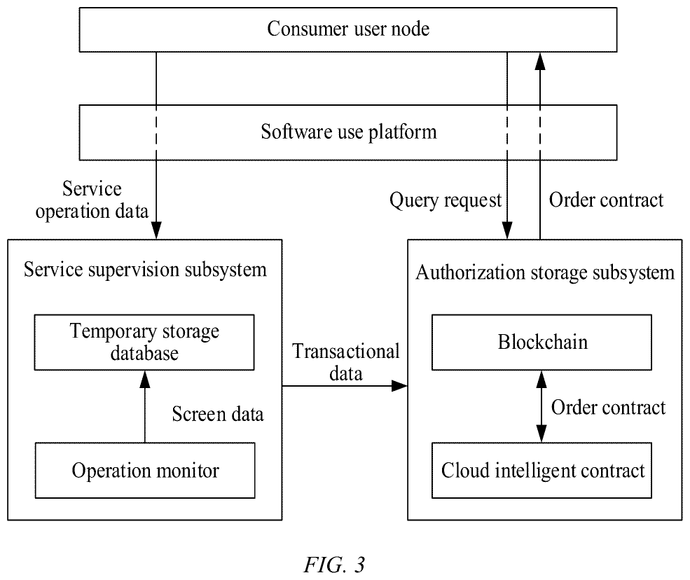

In this embodiment, as shown in FIG. 3, the code property management system further includes a service supervision subsystem.

The software use platform is further configured to, after detecting the payment completion operation in response to the payment bill, send a transaction record registration request to a blockchain in the repository through the service supervision subsystem, where transaction information carried in the transaction record registration request at least includes a product identifier of the target Docker software product, a user identifier of the consumer user node, and transaction process data. The blockchain generates an order contract based on the transaction record registration request and completes storage through a multi-node consensus mechanism.

Optionally, the transaction record registration request further includes at least one of a transaction time, a transaction amount, or transaction content.

The software use platform is further configured to, when receiving a query request sent by the consumer user node, send the query request to the blockchain, and deliver a received order contract returned by the blockchain to the consumer user node. The query request carries the user identifier of the consumer user node and/or the product identifier of the target Docker software product.

In this application, the service supervision subsystem monitors service usage data during software use, and uploads transaction records to the blockchain for evidencing, thereby improving transparency and traceability of software service transactions, and providing evidence for defending rights of the users.

In this embodiment, the construction request received by the software use platform includes a basic lifetime.

When the software use platform does not receive a delay request before the accumulative use duration of the target Docker software product delivered to the consumer user node reaches the basic lifetime, the total lifetime of the target Docker software product is determined as the basic lifetime.

When the software use platform receives a delay request carrying delay duration before the accumulative use duration of the target Docker software product delivered to the consumer user node reaches the basic lifetime, the software use platform sends the delay request to a creator user node corresponding to a target code project encapsulated in the target Docker software product, and after receiving agreement feedback from the creator user node corresponding to the target code project for the delay request, determines the total lifetime of the target Docker software product as a sum of the basic lifetime and the delay duration.

Optionally, delay duration requested by each consumer user node for a same Docker software product is less than or equal to a set delay threshold.

In this embodiment, the software use platform is further configured to perform the following operations:

when a suspension request carrying suspension duration sent by the consumer user node is received in a process of delivering the target Docker software product to the corresponding consumer user node, sending the suspension request to a creator user node corresponding to a target code project encapsulated in the target Docker software product.

After receiving agreement feedback from the creator user node corresponding to the target code project for the suspension request, delivery of the target Docker software product to the corresponding consumer user node is suspended until the suspension duration is reached, and the target Docker software product is continued to be delivered to the corresponding consumer user node, where the accumulative use duration of the target Docker software product does not increase in a process of suspending the delivery.

Optionally, suspension duration requested by each consumer user node for a same Docker software product is less than or equal to a set suspension threshold.

In this embodiment, the code property management system further includes a service supervision subsystem, and the service supervision subsystem is further configured to upload and store transactional data corresponding to the construction request to a blockchain of the repository through a multi-node consensus mechanism, the transactional data corresponding to each construction request includes a user identifier of the consumer user node sending the construction request, process data for compiling and generating the target Docker software product by the software compilation subsystem, and usage data for delivering the target Docker software product by the software use platform to the corresponding consumer user node.

Optionally, the process data for compiling and generating the target Docker software product by the software compilation subsystem includes a corresponding port number, an IP address, a product identifier, and a basic lifetime. The usage data includes a software delivery time, a delay request time, delay duration, a suspension request time, suspension duration, a user payment time, a software destruction time, and specific usage content corresponding to each time.

Optionally, as shown in FIG. 3, the service supervision subsystem includes an operation monitor and a temporary storage database. The operation monitor obtains service operation data of the consumer user node received by using the software use platform and stores transactional data in the temporary storage database. The cloud intelligent contract generates a user operation record table based on the transactional data, and uploads the user operation record table to the blockchain for evidencing.

In this embodiment, the creating platform generates a corresponding key pair for each creator user node that completes registration, correspondingly stores a user identifier of the creator user node and a public key in the generated key pair in the blockchain, and returns a private key in the generated key pair to the creator user node.

In an embodiment, the authorization storage subsystem further includes a digital certificate authority, and functions of the digital certificate authority includes:

(1) The digital certificate authority is configured to issue user identifiers to the creator user nodes.

After receiving a registration request carrying a creator identifier, the creating platform queries whether the blockchain stores the creator identifier. When the blockchain stores the creator identifier, the creating platform rejects the registration request. When the blockchain stores the creator identifier, the creating platform generates a corresponding creator user node and an RSA key pair for the creator identifier, sends an identity issuance request to the digital certificate authority, receives a user identifier of the creator user node fed back by the digital certificate authority, and stores the creator identifier of the creator user node, the corresponding RSA key pair, and the user identifier in a token. When receiving a login request carrying the token and sent by the creator user node, the creating platform responds to the login request.

The creator user nodes are distributed on several organizations, at least one creator user node in each organization has management permission, and the creator user node having the management permission is configured to upload the creator identifier to the blockchain.

Optionally, the creator identifier is a work number of the creator user node in a corresponding organization.

Optionally, an upper limit of a quantity of creator user nodes owned by each organization is equal. For example, each organization has at most 5 creator user nodes.

(2) The digital certificate authority is configured to issue user identifiers to consumer user nodes.

After receiving the registration request carrying the consumer identifier, the registration platform generates a corresponding consumer user node for the consumer identifier, sends an identity issuance request to the digital certificate authority, receives a user identifier of the consumer user node fed back by the digital certificate authority, and uploads the consumer identifier and the user identifier of the consumer user node to the blockchain and stores the consumer identifier and the user identifier in a token. When receiving a login request carrying the token and sent by the consumer user node, the registration platform responds to the login request.

Optionally, the registration platform is any one of a software use platform, an authorization storage subsystem, a software compilation subsystem, or a service supervision subsystem.

Optionally, after the consumer user node or the creator user node is registered, the user node that is not synchronized to the blockchain cannot participate in transaction. In addition, after set duration after registration is completed, the user node that is not synchronized to the blockchain is automatically removed by a monitoring node.

(3) The digital certificate authority is configured to authenticate the user identifier of the creator user node.

After receiving the code property data of the code project and the corresponding user identifier of the management node, the authorization storage subsystem checks integrity of token information of the management node, and sends an authentication request to the digital certificate authority based on the user identifier of the management node after the check is passed. When receiving authentication success feedback from the digital certificate authority, the authorization storage subsystem performs a step of reading the public key corresponding to the user identifier of the management node from the blockchain as the management public key of the code project. When receiving authentication failure feedback from the digital certificate authority, the authorization storage subsystem performs the step.

(4) The digital certificate authority is configured to authenticate the user identifier of the consumer user node.

After receiving the construction request, the software compilation subsystem further obtains the user identifier of the consumer user node by parsing, and sends an authentication request to the digital certificate authority based on the user identifier of the consumer user node. When receiving authentication success feedback from the digital certificate authority, the software compilation subsystem performs the step of sending the target property identifier to the authorization storage subsystem. When receiving authentication failure feedback from the digital certificate authority, the software compilation subsystem does not respond to the construction request.

The foregoing descriptions are merely preferred implementations of this application, and this application is not limited to the foregoing embodiments. It may be understood that other improvements and variations directly derived or conceived by a person skilled in the art without departing from the spirit and concept of this application shall fall within the protection scope of this application.

What is claimed is:

1. A code property management system based on compilation of a cloud intelligent contract, wherein the code property management system comprises an authorization storage subsystem, a software compilation subsystem, and a software use platform, and both the authorization storage subsystem and the software compilation subsystem are deployed in a cloud environment; the authorization storage subsystem comprises a repository and is deployed with a cloud intelligent contract, the repository correspondingly stores a property identifier and encrypted code property data of at least one code project, and code property data of each code project is encrypted by using a management public key of the code project;
the software use platform is configured to receive a construction request sent by a consumer user node, and the construction request carries a target property identifier and a target compiling environment corresponding to a target code project; the software use platform is further configured to send, based on the target property identifier, the construction request to a creator user node corresponding to the target code project, and send the construction request to the software compilation subsystem after receiving an authorization response from the creator user node corresponding to the target code project for the construction request;
the software compilation subsystem is configured to parse the received construction request and send the target property identifier to the authorization storage subsystem;
the authorization storage subsystem is configured to invoke the cloud intelligent contract to obtain encrypted target code property data corresponding to the target property identifier from the repository, and return the encrypted target code property data to the software compilation subsystem;
the software compilation subsystem is configured to push the encrypted target code property data to a virtual machine configured based on the target compiling environment, and compile the target code property data after decryption by using a management private key of the target code project in an isolated environment provided by the virtual machine, to generate a target Docker software product, wherein the target Docker software product is a Docker mirror of a software service for the construction request; the management public key and the management private key of each code project are a key pair; and
the software use platform is configured to deliver the target Docker software product to the consumer user node that sends the construction request.

2. The code property management system according to claim 1, wherein the code property management system further comprises a creating platform, and the repository comprises an interplanetary file system and a blockchain;
the creating platform is configured to obtain code property data of a code project uploaded by the creator user node and a user identifier of a corresponding management node and upload the code property data and the user identifier to the authorization storage subsystem, and a management node of each code project is a creator user node of the code project;
after receiving the code property data of the code project and the user identifier of the corresponding management node, the authorization storage subsystem reads a public key corresponding to the user identifier of the management node from the blockchain as the management public key of the code project, and triggers the cloud intelligent contract to generate the property identifier of the code project; the authorization storage subsystem is further configured to encrypt unstructured data in the code property data by using the management public key of the code project and then store the unstructured data in the interplanetary file system and obtain a storage address, and encrypt structured data in the code property data by using the management public key of the code project and then store the structured data in the blockchain corresponding to the property identifier of the code project and the storage address; and
that the encrypted target code property data corresponding to the target property identifier is obtained from the repository comprises: obtaining a storage address and encrypted structured data corresponding to the target property identifier from the blockchain, and obtaining encrypted unstructured data corresponding to the storage address from the interplanetary file system, wherein the obtained encrypted target code property data comprises the encrypted structured data and the encrypted unstructured data.

3. The code property management system according to claim 2, wherein that the creating platform obtains the code property data of the code project uploaded by the creator user node comprises:
obtaining local data uploaded by a plurality of creator user nodes with collaborative permission, and correspondingly storing user identifiers of all the creator user nodes with the collaborative permission and the local data uploaded by the creator user nodes, to obtain the code property data of the code project; and
each creator user node has consult permission for the local data uploaded by all the creator user nodes of the code project with the collaborative permission.

4. The code property management system according to claim 1, wherein each software product has a corresponding total lifetime;
the software use platform is further configured to stop delivering the target Docker software product to the consumer user node and send a destruction request for the target Docker software product to the software compilation subsystem when detecting that accumulative use duration of the target Docker software product delivered to the consumer user node reaches a total lifetime of the target Docker software product; and
the software compilation subsystem destructs the target Docker software product based on the received destruction request and recycles a port number of the target Docker software product, and different target Docker software products are respectively assigned different port numbers.

5. The code property management system according to claim 4, wherein the software use platform is further configured to push a payment bill to the consumer user node of the target Docker software product when detecting that the accumulative use duration of the target Docker software product delivered to the consumer user node reaches the total lifetime of the target Docker software product, and after detecting a payment completion operation in response to the payment bill, a Docker performs the step of stopping delivering the target Docker software product to the consumer user node and sending the destruction request for the target Docker software product to the software compilation subsystem.

6. The code property management system according to claim 5, wherein the code property management system further comprises a service supervision subsystem;
the software use platform is further configured to, after detecting the payment completion operation in response to the payment bill, send a transaction record registration request to a blockchain in the repository through the service supervision subsystem, wherein transaction information carried in the transaction record registration request at least comprises a product identifier of the target Docker software product, a user identifier of the consumer user node, and transaction process data; the blockchain generates an order contract based on the transaction record registration request and completes storage through a multi-node consensus mechanism;
the software use platform is further configured to, when receiving a query request sent by the consumer user node, send the query request to the blockchain, and deliver a received order contract returned by the blockchain to the consumer user node; and the query request carries the user identifier of the consumer user node and/or the product identifier of the target Docker software product.

7. The code property management system according to claim 4, wherein the construction request received by the software use platform comprises a basic lifetime;
when the software use platform does not receive a delay request before the accumulative use duration of the target Docker software product delivered to the consumer user node reaches the basic lifetime, the total lifetime of the target Docker software product is determined as the basic lifetime; and
when the software use platform receives a delay request carrying delay duration before the accumulative use duration of the target Docker software product delivered to the consumer user node reaches the basic lifetime, the software use platform sends the delay request to a creator user node corresponding to a target code project encapsulated in the target Docker software product, and after receiving agreement feedback from the creator user node corresponding to the target code project for the delay request, determines the total lifetime of the target Docker software product as a sum of the basic lifetime and the delay duration.

8. The code property management system according to claim 4, wherein the software use platform is further configured to perform the following operations:
when a suspension request carrying suspension duration sent by the consumer user node is received in a process of delivering the target Docker software product to the corresponding consumer user node, sending the suspension request to a creator user node corresponding to a target code project encapsulated in the target Docker software product; and
after receiving agreement feedback from the creator user node corresponding to the target code project for the suspension request, suspending delivery of the target Docker software product to the corresponding consumer user node until the suspension duration is reached, and continuing to deliver the target Docker software product to the corresponding consumer user node, wherein the accumulative use duration of the target Docker software product does not increase in a process of suspending the delivery.

9. The code property management system according to claim 1, wherein the code property management system further comprises a service supervision subsystem, and the service supervision subsystem is further configured to upload and store transactional data corresponding to the construction request to the blockchain of the repository through a multi-node consensus mechanism, the transactional data corresponding to each construction request comprises a user identifier of the consumer user node sending the construction request, process data for compiling and generating the target Docker software product by the software compilation subsystem, and usage data for delivering the target Docker software product by the software use platform to the corresponding consumer user node.

10. The code property management system according to claim 2, wherein the creating platform generates a corresponding key pair for each creator user node that completes registration, correspondingly stores a user identifier of the creator user node and a public key in the generated key pair in the blockchain, and returns a private key in the generated key pair to the creator user node.
